(19) United States
(12) Patent Application Publication
(10) Pub. No.: US 2009/0128962 A1
(43) Pub. Date: May 21, 2009

(54) READ-HEAD, MAGNETIC HEAD AND MAGNETIC STORAGE APPARATUS

(75) Inventors: Junichirou Murai, Kawasaki (JP); Masanori Akie, Kawasaki (JP); Hitoshi Kanai, Kawasaki (JP); Kazuo Kobayashi, Kawasaki (JP); Yuji Uehara, Kawasaki (JP); Xiaoxi Liu, Nagano (JP); Akimitsu Morisako, Nagano (JP)

Correspondence Address: GREER, BURNS & CRAIN, 300 S WACKER DR, 25TH FLOOR, CHICAGO, IL, 60606, US

(73) Assignees: FUJITSU LIMITED, Kawasaki-shi (JP); SHINSHU UNIVERSITY, Matsumoto-shi (JP)

(21) Appl. No.: 12/271,473

(22) Filed: Nov. 14, 2008

(30) Foreign Application Priority Data
Nov. 15, 2007 (JP) 2007-296500

(51) Int. Cl. G11B 5/33

(52) U.S. Cl. 360/313; G9B/5.104

(57) ABSTRACT

The read-head is capable of corresponding to high recording density without deteriorating characteristics even if a small size read-element is used. The read-head of the present invention comprises: a read-element including a free layer; and a magnetic domain control layer for domain-controlling the free layer. The magnetic domain control layer is composed of a soft magnetic material including at least one substance selected from the group consisting of Fe, Co and Ni. A ratio (a/b) of a length (a) of the magnetic domain control layer in the core width direction to a length (b) thereof in the height direction is 5 or more, and the length (b) is 100 nm or less.

### BACKGROUND OF THE INVENTION

The present invention relates to a read-head, a magnetic having a read-head, and a magnetic storage apparatus having a magnetic head.

A read-head of a magnetic head, which is built into a magnetic storage apparatus, includes a read-element, e.g., magnetoresistance (MR) element, spin-valve giant magnetoresistance (GMR) element, tunneling magnetoresistance (TMR) element, current perpendicular plane (CPP)-GMR element. The read-element has a free layer, whose magnetization direction is varied by magnetically recorded data (magnetic fields) of a magnetic recording medium, and a pinned magnetic layer, whose magnetization direction is fixed. Bias magnetic fields are applied to the free layer. When no external magnetic fields are applied to the free layer, the magnetization direction of the free layer is controlled to be perpendicular to that of the pinned magnetic layer.

A conventional TMR read-head is shown in FIG. 10. A read-element 10 is sandwiched, between magnetic domain control layers 12a and 12b, in the core width direction. With this structure, the free layer of the read-element 10 can be domain-controlled by applying bias magnetic fields thereto. The magnetic domain control layers 12a and 12b are composed of a hard magnetic material having a high coercive force, e.g., CoCrPt, CoCr.

Further, the read-element 10 is sandwiched, between a lower shielding layer 14 and an upper shielding layer 16, in the thickness direction. Side faces of the read-element 10 and a surface of the lower shielding layer 14, which is extended sideward from the side faces of the read-element 10, are coated with insulating layers 18 so as to pass a sensing current between the lower shielding layer 14 and the upper shielding layer 16. The magnetic domain control layers 12a and 12b and the upper shielding layer 16 are formed on base layers 121 and 161.

The above described conventional read-head is disclosed in, for example, Japanese Laid-open Patent Publication No. 10-335714 and No. 2006-190360.

By the way, magnetic recording densities of the recording media are increased, so read-elements are highly downsized so as to detect magnetic fields in significantly minute areas. Generally, in a small size read-element, the free layer for detecting magnetic fields is highly influenced by demagnetizing fields. Therefore, a magnetic domain structure of the free layer is easily changed from a unitary structure to a wide variety of structures. As a result, output signals of the read-element will be destabilized, and noises will be increased.

### SUMMARY OF THE INVENTION

The present invention was conceived to solve the above described problems.

An object of the present invention is to provide a read-head, which is capable of corresponding to high recording density without deteriorating characteristics even if a small size read-element is used.

Another object is to provide a magnetic head including the read-head of the present invention.

Further object is to provide a magnetic storage apparatus including the magnetic head of the present invention.

To achieve the objects, the present invention has following constitutions.

Namely, the read-head of the present invention comprises a read-element, which includes, a free layer and a magnetic domain control layer for domain-controlling the free layer; the magnetic domain control layer is composed of a soft magnetic material including at least one substance selected from the group consisting of Fe, Co and Ni; a ratio (a/b) of a length (a) of the magnetic domain control layer in the core width direction to a length (b) thereof in the height direction is 5 or more; and the length (b) is 100 nm or less.

In the read-head, the magnetic domain control layer may be composed of FeCo. With this structure, the soft magnetic material, which has effective magnetic anisotropy and high saturation magnetic flux density (Bs), can be suitably used.

In the read-head, the magnetic domain control layer may be composed of a soft magnetic material whose saturation magnetic flux density (Bs) is 1 T or more. With this structure, even if the magnetic domain control layer is thinner, suitable magnetic domain control of the free layer can be performed.

In the read-head, corners of the magnetic domain control layer are rounded. With this structure, the magnetic domain control layer can be stabilized and can have a unitary magnetic domain structure, so that the magnetic domain control of the free layer can be effectively performed.

In the read-head, the magnetic domain control layer may be a flat layer whose thickness is nearly equal to that of the read-element. With this structure, leakage of magnetic flux can be restrained, and the magnetic domain control of the free layer can be effectively performed.

The read-head of the present invention can be effectively used in a magnetic head comprising a read-head and a write-head.

Further, the magnetic head can be used in a magnetic storage apparatus, so that recording density of the magnetic storage apparatus can be increased.

In the present invention, the magnetic domain control layer for domain-controlling the free layer of the read-element is composed of the soft magnetic material, and size effect of the soft magnetic material is used, so that bias magnetic fields can be effectively applied to the free layer of the read-element. Therefore, even if the read-element is highly downsized, the read-head, which is capable of effectively using the downsized read-element, can be provided. The read-head is capable of realizing a magnetic head and a magnetic storage apparatus corresponding to high density recording.

### BRIEF DESCRIPTION OF THE DRAWINGS

Embodiments of the present invention will now be described by way of examples and with reference to the accompanying drawings, in which:

FIG. 1 is a sectional view of a read-head of the present invention;

FIG. 2 is a perspective view showing an arrangement of magnetic domain control layers having rectangular planar shapes;

FIG. 3 is a sectional view of another read-head;

FIG. 4 is a graph of magnetization curves of soft magnetic films;

FIG. 5 is a graph of magnetization curves of soft magnetic films;

FIGS. 6A-6D are plan views of other examples of the magnetic domain control layers;

FIG. 7 is a sectional view of a magnetic head;

FIG. 8 is a perspective view of a head slider;

FIG. 9 is a plan view of a magnetic storage apparatus; and

FIG. 10 is a sectional view of the conventional read-head.

### DETAILED DESCRIPTION OF THE EMBODIMENTS

Preferred embodiments of the present invention will now be described in detail with reference to the accompanying drawings.

### (Read-Head)

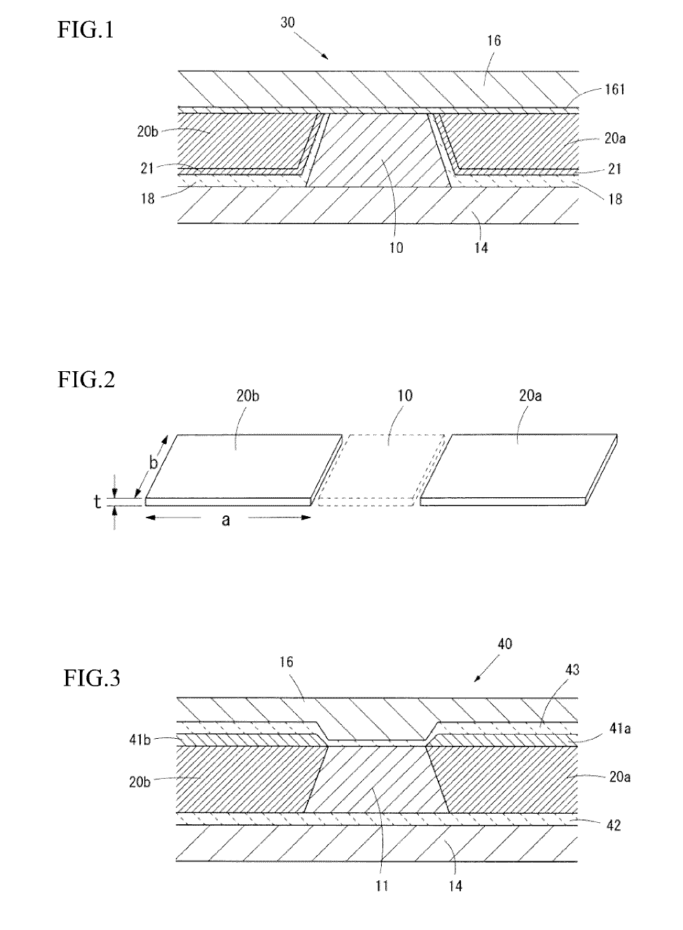

A TMR read-head 30, which is an example of a read-head included in a magnetic head, is shown in FIG. 1. In FIG. 1, the read-head 30 is seen from an air bearing surface side of a head slider. In the read-head 30, a read-element 10 is sandwiched, between a lower shielding layer 14 and an upper shielding layer 16, in the thickness direction. Magnetic domain control layers 20a and 20b are respectively provided on the both sides of the read-element 10 and sandwiched between the lower shielding layer 14 and the upper shielding layer 16.

Side faces of the read-element 10 and a surface of the lower shielding layer 14, which is extended sideward from the side faces of the read-element 10, are coated with insulating layers 18. Base layers 21 coating surfaces of the insulating layers 18 are used as seed layers when the magnetic domain control layers 20a and 20b are formed by plating. The base layers 21 makes the magnetic domain control layers 20a and 20b grow in prescribed crystal face directions. A base layer 161 is used as a seed layer when the upper shielding layer 16 is formed by plating.

In the read-head 30 of the present embodiment, the magnetic domain control layers 20a and 20b, which are provided on the both sides of the read-element 10, are flat layers whose thickness is nearly equal to that of the read-element 10, and upper faces of the magnetic domain control layers 20a and 20b are level with the uppermost layer of the read-element 10. With this structure, the upper shielding layer 16 is made flat, and a surface of the upper shielding layer 16 is parallel to that of the lower shielding layer 14.

By making the magnetic domain control layers 20a and 20b and the upper shielding layer 16 flat, leaking magnetic flux of the magnetic domain control layers 20a and 20b to the upper shielding layer 16 can be restrained, and bias magnetic fields of the magnetic domain control layers 20a and 20b can be effectively applied to the free layer of the read-element 10.

In the conventional read-head 30 shown in FIG. 10, thicknesses of the magnetic domain control layers 12a and 12b are gradually increased with separating away from the read-element 10. By thickening the magnetic domain control layers 12a and 12b, the bias magnetic fields can be increased. To sufficiently perform the magnetic domain control with the magnetic domain control layers 12a and 12b, the magnetic domain control layers 12a and 12b must have prescribed coercive forces (Hc) and prescribed tBs values (film thickness X saturation magnetic flux density). Thickening the magnetic domain control layers 12a and 12b is effective for increasing the tBs values.

However, by thickening the magnetic domain control layers 12a and 12b, the magnetic domain control layers 12a and 12b get into the upper shielding layer 16. With this structure, magnetic flux is easily leaked from upper parts of the magnetic domain control layers 12a and 12b to the upper shielding layer 16. If the read-element 10 is downsized and a core width is reduced, a distance between the magnetic domain control layers 12a and 12b, which sandwich the read-element 10, is shortened. Therefore, the magnetic flux is further easily leaked from the magnetic domain control layers 12a and 12b to the upper shielding layer 16.

On the other hand, in the read-head 30 of the present embodiment, the upper shielding layer 16 is flat, and the thicknesses of the magnetic domain control layers 20a and 20b are nearly equal to that of the read-element 10, so that leakage of magnetic flux from the magnetic domain control layers 20a and 20b to the upper shielding layer 16 can be restrained.

However, in comparison with the case of thickening the magnetic domain control layer, the tBs values are limited when the thicknesses of the magnetic domain control layers 20a and 20b are nearly equal to that of the read-element 10. In case of employing the structure of the read-head 10 shown in FIG. 1, a material having a greater Bs value is required.

The read-head 10 of the present embodiment shown in FIG. 1 is characterized in that the magnetic domain control layers 20a and 20b, which domain-control the free layer of the read-element 10, are composed of a soft magnetic material. Generally, a soft magnetic material does not have a sufficient coercive force Hc and a sufficient tBs value alone. Thus, the magnetic domain control layers composed of the soft magnetic material are combined with antiferromagnetic layers (see Japanese Patent Gazette No. 2006-190360). On the other hand, in the present embodiment, the magnetic domain control layers 20a and 20b are composed of the soft magnetic material alone. Note that, in the present embodiment, the magnetic domain control is performed by the soft magnetic layers alone, so the size effect of the soft magnetic layers is used for the magnetic domain control layers 20a and 20b.

FIG. 2 is a perspective view of the magnetic domain control layers 20a and 20b having rectangular planar shapes.

In FIG. 2, a length of each of the magnetic domain control layers 20a and 20b in the core width direction is indicated as “a”, a length of thereof in the height direction is indicated as “b” and a thickness thereof is indicated as “t”. The inventors found that shape anisotropy appeared in the magnetic domain control layers composed of the soft magnetic material and a high coercive force coequal to that of a hard magnetic material could be obtained when the lengths “t” are about 100 nm or less. In the read-head of the present embodiment, magnetic anisotropy is produced by limiting sizes of the soft magnetic layers. The magnetic domain control layers 20a and 20b are formed on the basis of this effect.

Generally, single layers of a soft magnetic material cannot be used as the magnetic domain control layers. On the other hand, in the present embodiment, single layers of the soft magnetic material can be used as the magnetic domain control layers 20a and 20b under prescribed conditions.

The read-head 30 shown in FIG. 1 is the TMR read-head, and the read-element 10 includes a pinned magnetic layer whose magnetization direction is fixed, an insulating layer allowing to pass an electric current by a tunneling effect, and a free layer whose magnetization direction is varied by magnetic fields applied from a recording medium. Constitutions of magnetic layers, insulating layers, antiferromagnetic layers, etc. of the read-element 10 are the same as the conventional read-element. In the present invention, the structure of the read-element 10 is not limited, so various types of read-elements can be employed.

The lower shielding layer 14 and the upper shielding layer 16 shield adjacent magnetic fields of the recording medium, and they are composed of a soft magnetic material, e.g., NiFe. In the TMR read-head, the lower shielding layer 14 and the upper shielding layer 16 further act as electrodes for passing a sensing current.

The insulating layers 18 insulate the lower shielding layer 14 from the upper shielding layer 16, and they are composed of an insulating material, e.g., Alo, MgO, SiO₂.

In the present embodiment, the magnetic domain control layers 20a and 20b are composed of the soft magnetic material, e.g., FeCo.

The magnetic domain control layers 20a and 20b composed of FeCo may be formed by the steps of: laminating prescribed magnetic layers, etc. on a work (wafer) composed of Al-TiC so as to form the read-element 10; coating a surface of the work with, for example, alumina so as to form the insulating layers 18; forming the base layers 21 composed of, for example, Cr by sputtering; and forming the FeCo layers 20a and 20b on the base layers 21 by a plating method, in which the base layers 21 are used as electric power feeding layers. Note that, the base layers 21 are composed of at least one substance selected from the group consisting of Cr, W. Ti, Mo, Pd, Hf. Si and Ru. Further, at least one substance selected from the group consisting of B, Ga, Zr, Nb and Hf may be further added to the above selected substance or substances.

Next, the base layer 161 is formed on the surface of the work, and the upper shielding layer 16 composed of, for example, NiFe is formed by a plating method, in which the base layer 161 is used as an electric power feeding layer. By forming the upper shielding layer 16 having a prescribed thickness, the read-head 30 is completed.

In the above described embodiment, the TMR read-head has been explained as a CPP type read-head. Further, domain-controlling the free layer of the read-element with the magnetic domain control layers 20a and 20b composed of the soft magnetic material may be applied to a current in plane (CIP) type read-head as well as the CPP type read-head.

FIG. 3 shows a CIP type read-head 40 having the magnetic domain control layers 20a and 20b composed of the soft magnetic material. In the read-head 40, a sensing current passes via lead terminals 41a and 41b, which are provided on the both sides of a read-element 11. The lower shielding layer 14 is electrically insulated from the magnetic domain control layers 20a and 20b by an insulating layer 42, and the upper shielding layer 16 is electrically insulated from the lead terminals 41a and 41b by an insulating layer 43.

### (Magnetic Anisotropy of Soft Magnetic Material)

Characteristics of the rectangular magnetic domain control layers (soft magnetic films) shown in FIG. 2 were examined.

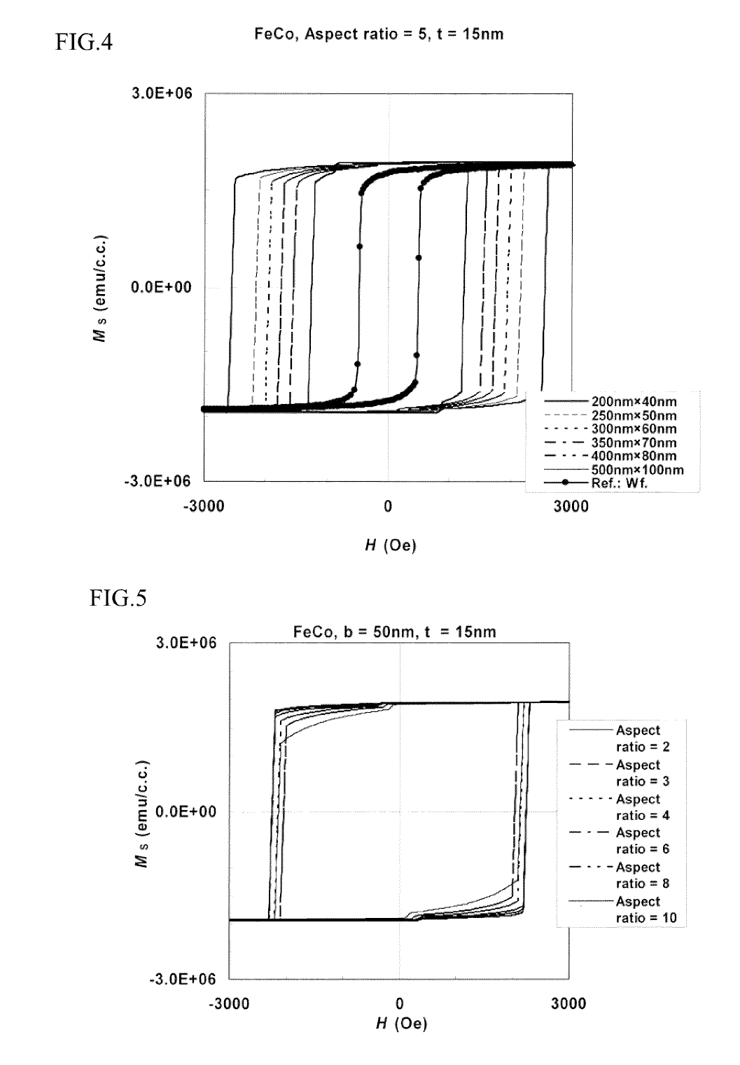

FIG. 4 is a graph of magnetization curves of six samples (soft magnetic films). In the samples, the ratio (a/b) of “the length (a) of long sides of the rectangular soft magnetic film” to “the length (b) of short sides thereof” was fixed to 5, but the lengths (a) and (b) were varied. Note that, the soft magnetic films were FeCo films and their thickness (t) was 15 nm. Thicknesses of ordinary read-elements are 30 nm or less. The thickness of the samples, i.e., 15 nm, is a normal thickness of a TMR element. For comparison, a magnetization curve of a mere FeCo film, from which the size effect could not be obtained, was measured (see “Ref.: Wf.” in FIG. 4).

The lengths (a) and (b) of the six samples were 200×40 nm, 250×50 nm, 300×60 nm, 350×70 nm, 400×80 nm and 500×100 nm. Namely, the ratio (a/b) was fixed to 5 in all of the samples, but the lengths (a) and (b) were differed in the samples.

According to the results, in case of using the soft magnetic films as the magnetic domain control layers, when the length (b) of the short sides was 100 nm or less, coercive forces Hc of the soft magnetic films (FeCo films) met a condition of 1200 (Oe), which is a minimum required coercive force of magnetic domain control layers. Namely, effective magnetic domain control function can be obtained when the ratio (a/b) of the length (a) to the length (b) is 5 and the length (b) is 100 nm or less.

FIG. 5 is a graph of magnetization curves of six samples (soft magnetic films). In the samples, the lengths (b) were fixed to 50 nm, and the ratios (a/b) were varied. The thicknesses (t) of the samples was 15 nm, and the ratios (a/b) were 2, 3, 4, 6, 8 and 10.

According to the results, when the ratio (a/b) was 6, the magnetization curves were formed into rectangular shapes; when the ratio (a/b) was 4 or less, the magnetization curves deviated from the rectangular shapes. Therefore, the ratio (a/b) should be 5 or more so as to produce the soft magnetic films having suitable magnetic anisotropy.

According to FIGS. 4 and 5, the soft magnetic films, which have rectangular planar shapes and in each of which the ratio (a/b) is 5 or more and the length (b) is 100 nm or less, have sufficient coercive forces, which meet the required coercive force of the magnetic domain control layer composed of the soft magnetic film alone. Therefore, the soft magnetic films can be suitably used as the magnetic domain control layers 20a and 20b for domain-controlling the free layer of the read-element. In case of using the FeCo films as the soft magnetic layers, A Bs value of FeCo is very high, e.g., 2.4 T, so the required tBs value of the magnetic domain control layer can be gained even if the thickness of the magnetic domain control layers 20a and 20b is thinned. A required Bs value of the magnetic domain control layer composed of the soft magnetic film is about 1 T or more.

These days, recording densities of recording media have been highly increased, and read-elements have been highly downsized. In the present invention, the lengths (b) of the magnetic domain control layers of the read-head in the height direction are shortened to 100 nm or less, namely the magnetic anisotropy caused by the size effect can be obtained by highly downsizing the magnetic domain control layers. The technology can be effectively applied to small read-heads.

Note that, in the above described embodiments, the soft magnetic FeCo films are used as the magnetic domain control layers 20a and 20b, but other soft magnetic films other than FeCo can be used as well. For example, a soft magnetic material including at least one substance selected from the group consisting of Fe, Co and Ni may be used.

### (Planar Shapes of Magnetic Domain Control Layers)

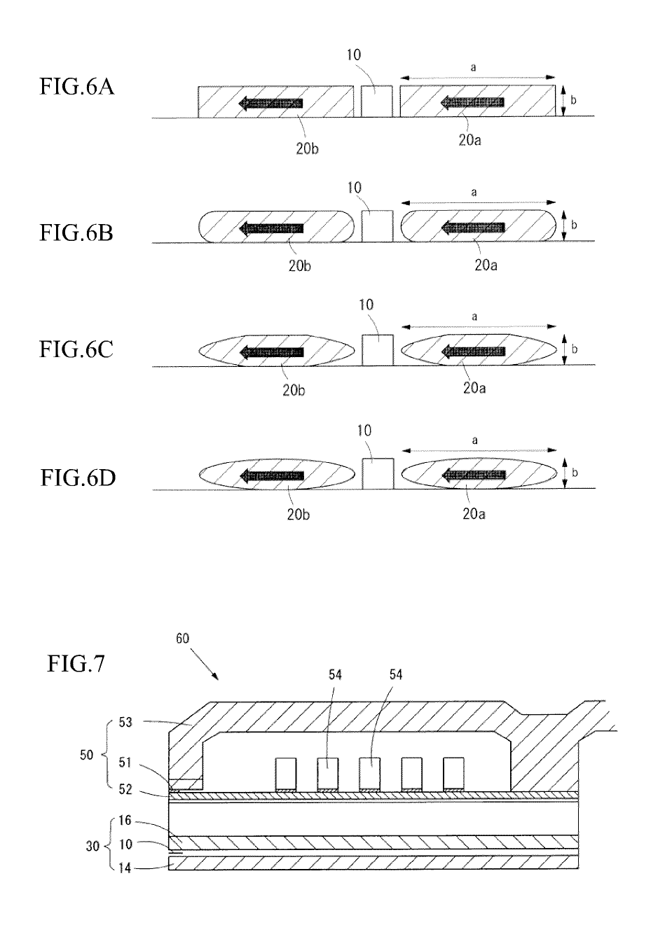

FIGS. 6A-6D show examples of the magnetic domain control layers 20a and 20b of the read-head. FIG. 6A shows the above described magnetic domain control layers 20a and 20b having the rectangular planar shapes. In the final step of a production process of a magnetic head, the magnetic domain control layers 20a and 20b are magnetized in one direction by applying external magnetization fields thereto. By this magnetizing step, each of the magnetic domain control layers 20a and 20b has a unitary magnetic domain. However, in some cases, each of the magnetic domain control layers 20a and 20b will be divided into a plurality of magnetic domains.

If the magnetic domain control layers 20a and 20b are divided into a plurality of magnetic domains, intensities of bias magnetic fields applied from the magnetic domain control layers 20a and 20b to the read-element are smaller than those applied from the magnetic domain control layers having the unitary magnetic domains. Preferably, the magnetic domain control layers 20a and 20b stably have the unitary magnetic domains. If the magnetic domain control layers have sharply-angled corners, the magnetic domain will be easily divided from the sharply-angled corners. Therefore, the sharply-angled corners of the magnetic domain control layers 20a and 20b should be removed so as to stabilize the unitary magnetic domain structure of the magnetic domain control layers 20a and 20b.

In each of FIGS. 6B-6D, the sharply-angled corners of the rectangular magnetic domain control layers 20a and 20b shown in FIG. 6A are rounded so as to securely maintain, as a whole, the unitary magnetic domain structure of the magnetic domain control layers 20a and 20b. In FIG. 6B, longitudinal ends of the magnetic domain control layers 20a and 20b are formed into semicircle shapes. In FIG. 6C, longitudinal ends of the magnetic domain control layers 20a and 20b are formed into elliptical shapes. In FIG. 6D, the entire magnetic domain control layers 20a and 20b are formed into elliptical shapes. In each of the shown examples too, the magnetic anisotropy of the magnetic domain control layers 20a and 20b composed of the soft magnetic material can be obtained by limiting the length (b) of the magnetic domain control layers 20a and 20b to 100 nm or less and limiting the ratio (a/b) thereof 5 or more.

### (Magnetic Head & Magnetic Storage Apparatus)

FIG. 7 is a sectional view of a magnetic head 60, which includes the above described read-head 30, seen from a direction perpendicular to an air bearing surface. The magnetic head 60 is a vertical recording head. The magnetic head 60 comprises the read-head 30 and a write-head 50. In the read-head 30 whose magnetic domain control layers (not shown) are composed of the above described soft magnetic material, the read-element 10 is sandwiched between the lower shielding layer 14 and the upper shielding layer 16. The magnetic domain control layers are provided on the both sides of the read-element 10.

The write-head 50 comprises a main magnetic pole 52, a return yoke 53 and a write-gap 51 formed between the main magnetic pole 52 and the return yoke 53. Symbols 54 stand for coils for writing data.

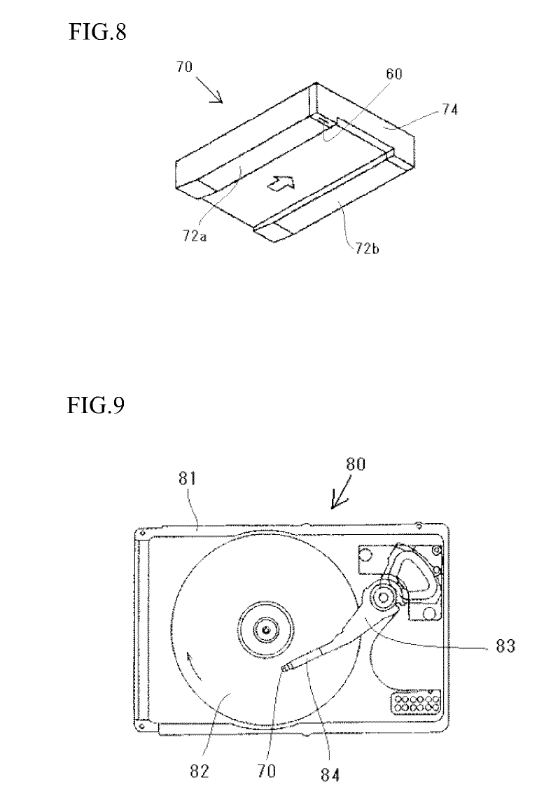

FIG. 8 is a perspective view of a head slider 70 on which the magnetic head 60 is mounted. In the head slider 70, float rails 72a and 72b are formed in the air bearing surface facing a magnetic disk, and the magnetic head 60 is provided to a front end part of the slider 70 and coated with a protection film 74.

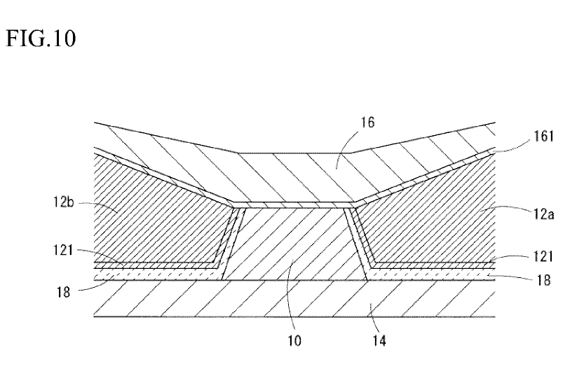

FIG. 9 shows a magnetic storage apparatus 80 including the above described magnetic head. In the magnetic storage apparatus 80, a plurality of magnetic disks 82 are provided in a casing 81 and rotated by a spindle motor. Carriage arms 83 are swingably provided in the vicinity of the magnetic disks 82. Head suspensions 84 are respectively provided to front ends of the carriage arms 33. The head sliders 70 are respectively provided to front ends of the head suspensions 84.

The head sliders 70 are elastically biased, by the head suspensions 84, toward surfaces of the magnetic disks 82. By rotating the magnetic disks 82 by the spindle motor, air streams are generated so that the head sliders 70 are floated and moved away from the surfaces of the magnetic disks 82 until the floating forces are balanced with the biasing forces of the head suspensions 84. Therefore, the head sliders 70 are separated a prescribed distance away from the surfaces of the magnetic disks 82 and maintains such states, so that data can be read from and written on the magnetic disks 82.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A read-head,
comprising:
a read-element including a free layer; and
a magnetic domain control layer for domain-controlling the free layer,
wherein the magnetic domain control layer is composed of a soft magnetic material including at least one substance selected from the group consisting of Fe, Co and Ni,
a ratio (a/b) of a length (a) of the magnetic domain control layer in the core width direction to a length (b) thereof in the height direction is 5 or more, and
the length (b) is 100 nm or less.

2. The read-head according to claim 1,
wherein the magnetic domain control layer is composed of FeCo.

3. The read-head according to claim 1,
wherein the magnetic domain control layer is composed of a soft magnetic material whose saturation magnetic flux density (Bs) is 1 T or more.

4. The read-head according to claim 1,
wherein corners of the magnetic domain control layer are rounded.

5. The read-head according to claim 1,
wherein the magnetic domain control layer is a flat layer whose thickness is nearly equal to that of the read-element.

6. A magnetic head,
comprising:
a read-head; and
a write-head,
wherein the read-head has a read-element, which includes a free layer, and a magnetic domain control layer for domain-controlling the free layer,
the magnetic domain control layer is composed of a soft magnetic material including at least one substance selected from the group consisting of Fe, Co and Ni,
a ratio (a/b) of a length (a) of the magnetic domain control layer in the core width direction to a length (b) thereof in the height direction is 5 or more, and
the length (b) is 100 nm or less.

7. The magnetic head according to claim 6,
wherein the magnetic domain control layer is composed of FeCo.

8. The magnetic head according to claim 6,
wherein the magnetic domain control layer is composed of a soft magnetic material whose saturation magnetic flux density (Bs) is 1 T or more.

9. The magnetic head according to claim 6,
wherein corners of the magnetic domain control layer are rounded.

10. The magnetic head according to claim 6,
wherein the magnetic domain control layer is a flat layer whose thickness is nearly equal to that of the read-element.

11. A magnetic storage apparatus,
comprising:
a magnetic head, which includes a read-head,
wherein the read-head has a read-element, which includes a free layer, and a magnetic domain control layer for domain-controlling the free layer,
the magnetic domain control layer is composed of a soft magnetic material including at least one substance selected from the group consisting of Fe, Co and Ni,
a ratio (a/b) of a length (a) of the magnetic domain control layer in the core width direction to a length (b) thereof in the height direction is 5 or more, and
the length (b) is 100 nm or less.

12. The magnetic storage apparatus according to claim 11,
wherein the magnetic domain control layer is composed of FeCo.

13. The magnetic storage apparatus according to claim 11,
wherein the magnetic domain control layer is composed of a soft magnetic material whose saturation magnetic flux density (Bs) is 1 T or more.

14. The magnetic storage apparatus according to claim 11,
wherein corners of the magnetic domain control layer are rounded.

15. The magnetic storage apparatus according to claim 11,
wherein the magnetic domain control layer is a flat layer whose thickness is nearly equal to that of the read-element.
